(19) United States
(12) Patent Application Publication
(10) Pub. No.: US 2007/0200858 A1
(43) Pub. Date: Aug. 30, 2007

(54) KVM switch and a computer switching method

(75) Inventors: Chih-Iao Hsieh, Taipei Hsien (TW); Chi-Hung Kao, Taipei Hsien (TW); Chin-Chou Lin, Taipei Hsien (TW)

Correspondence Address: BIRCH STEWART KOLASCH & BIRCH, PO BOX 747, FALLS CHURCH, VA, 22040-0747, US

(73) Assignee: ATEN INTERNATIONAL CO., LTD

(21) Appl. No.: 11/362,730

(22) Filed: Feb. 28, 2006

(51) Int. Cl. G06F 15/80

(52) U.S. Cl. 345/505

(57) ABSTRACT

A KVM switch has a switching device, a first computer video interface, a second computer video interface, an image processing unit, and at least one console video interface. The switching device is arranged to select a first computing device and a second computing device from the computing devices. The first computer video interface is arranged to receive a first image from the first computing device, and the second computer video interface is arranged to receive a second image from the second computing device. The image processing unit is arranged to compose the first image and the second image to be a synthesized image. The console video interface is arranged to output one of the first image, the second image and the synthesized image to the set of user interface devices.

### BACKGROUND

1. Field of Invention

The present invention relates to a KVM switch. More particularly, the present invention relates to a KVM switch that has image processing functions of image scaling and image overlaying.

2. Description of Related Art

With the rapid development in information technology, computers and their peripherals have become very popular. Typically, each computer is equipped with one set of user interface devices, possibly including a keyboard, a mouse and a monitor. However, this equipment wastes money and occupies too much space if one has several computers. Therefore, a keyboard-video-mouse (KVM) switch is proposed to use at least one set of user interface devices to manage several computers and their peripherals. Using the KVM switch reduces hardware costs and decreases waste of space while simultaneously conquering the problem of compatibility between different interfaces.

FIG. 1 is a schematic view depicting a traditional KVM switch of the prior art. Computing devices 135, 145 and a user interface device 161 are coupled with a KVM switch 110, which is arranged to route signals therebetween. A user can thereby use the user interface device 161 to obtain the output images of the computing devices 135, 145 through the KVM switch 110. However, the traditional KVM switch 110 can only transmit the image to the user interface device without processing the output images of the computing devices. Therefore, the user cannot get two output images from different computing devices simultaneously on the user interface device 161.

Alternatively, when the KVM switch 110 supports network connection (KVM over IP), a remote computing device 185 can connect to the KVM switch 110 by the network 150. When the user wants to view the output images of the computing devices 135, 145 simultaneously (such as in picture-in-picture or picture-on-picture formats) by the remote computing device 185, the output images of the computing devices 135, 145 need to be transmitted to the remote computing device 185 first, which then processes the images by image scaling or image overlaying. This kind of traditional device increases the data translating load between the remote computing device 185 and KVM switch 110; in other words, the data translating load of the network 150 is increased.

### SUMMARY

It is therefore an aspect of the present invention to provide a KVM switch, which has image processing functions and routes paths between computing devices, user interface devices and remote computing devices.

According to one preferred embodiment of the present invention, the KVM switch comprises a switching device, a first computer video interface, a second computer video interface, an image processing unit and at least one console video interface.

The switching device is arranged to route signals between sets of user interface devices and the computing devices, wherein the switching device selects the first computing device and the second computing device from the computing devices to be connected to the set of user interface devices. The first computer video interface is arranged to receive a first image from the first computing device, and the second computer video interface is arranged to receive a second image from the second computing device. The image processing unit coupled to the first computer video interface and the second computer video interface is arranged to compose the first image and the second image to be a synthesized image, such as a PIP(picture-in-picture) Image. The image processing unit further comprises an image scaler coupled to the first computer video interface and the second computer video interface, image scaler is arranged to shrink or enlarge at least one of the first image and the second image. The console video interface electrically connected to the switching device and the image processing unit is arranged to selectively output one of the first image, the second image and the synthesized image to the set of user interface devices.

According to another preferred embodiment of the present invention, the KVM switch comprises a switching device, a first computer video interface, a second computer video interface, an Application Specific Integrated Circuit (ASIC), at least one console video interface and a network communicating unit.

The switching device is arranged to route signals between sets of user interface devices, the remote computing devices and the computing devices, wherein the switching device selects a first computing device and a second computing device from the computing devices to be connected to at least one of user interface devices and the remote computing devices. The first computer video interface is arranged to receive a first image from the first computing device, and the second computer video interface is arranged to receive a second image from the second computing device.

The ASIC, a multifunctional integrated circuit, comprises an image processing unit, an image scaler and an image compressing unit. The image processing unit coupled to the first computer video interface and the second computer video interface is arranged to compose the first image and the second image to be a synthesized image. The image scaler coupled to the first computer video interface and the second computer video interface is arranged to shrink or enlarge at least one of the first image and the second image. The image compressing unit coupled to the first computer video interface, the second computer video interface and the image processing unit is arranged to compress at least one of the first image, the second image and the synthesized image into a compressed data.

The console video interface electrically connected to the switching device and the image processing unit is arranged to selectively output one of the first image, the second image and the synthesized image to the set of user interface devices. The network communicating unit coupled to the image compressing unit and the switching device is arranged to output the compressed data to a remote computing device.

It is another aspect of the present invention to provide a computer switching method, which has image processing functions and routes paths between the computing devices, user interface devices and remote computing devices.

According to one preferred embodiment of the present invention, the method is provided for a set of user interface devices to share a plurality of computing devices described as follows. A switching device is used to route signals between the set of user interface devices and the computing devices, and a first computing device and a second computing device are selected from the computing devices to be connected to the set of user interface devices. A first computer video interface is used to receive a first image from the first computing device. A second computer video interface is used to receive a second image from the second computing device. An image processing unit is used to compose the first image and the second image to be a synthesized image. At least one console video interface is used to selectively output the first image, the second image and the synthesized image to the set of user interface devices. An image compressing unit is used to compress at least one of the first image, the second image and the synthesized image into a compressed data. A network communicating unit is used to output the compressed data for a remote computing device.

According to the descriptions above, the KVM switch of the preferred embodiments of the present invention has image processing functionality to process the images directly, saving abundant time in transferring the images.

It is to be understood that both the foregoing general description and the following detailed description are examples and are intended to provide further explanation of the invention as claimed.

### BRIEF DESCRIPTION OF THE DRAWINGS

These and other features, aspects, and advantages of the present invention will become better understood with regard to the following description, appended claims, and accompanying drawings where:

FIG. 1 is a schematic view depicting a traditional KVM switch of the prior art;

FIG. 2A is a functional block diagram depicting a KVM switch of one preferred embodiment of the present invention;

FIG. 2B is a functional block diagram depicting a KVM switch of another preferred embodiment of the present invention;

FIG. 3A is a functional block diagram depicting a KVM switch of another preferred embodiment of the present invention;

FIG. 3B is a functional block diagram depicting a KVM switch of another preferred embodiment of the present invention;

FIG. 4 is a functional block diagram depicting an image processing unit of one preferred embodiment of the present invention;

FIG. 5A is a functional block diagram depicting an image overlay unit of one preferred embodiment of the present invention; and

FIG. 5B is a functional block diagram depicting an image overlay unit of another preferred embodiment of the present invention.

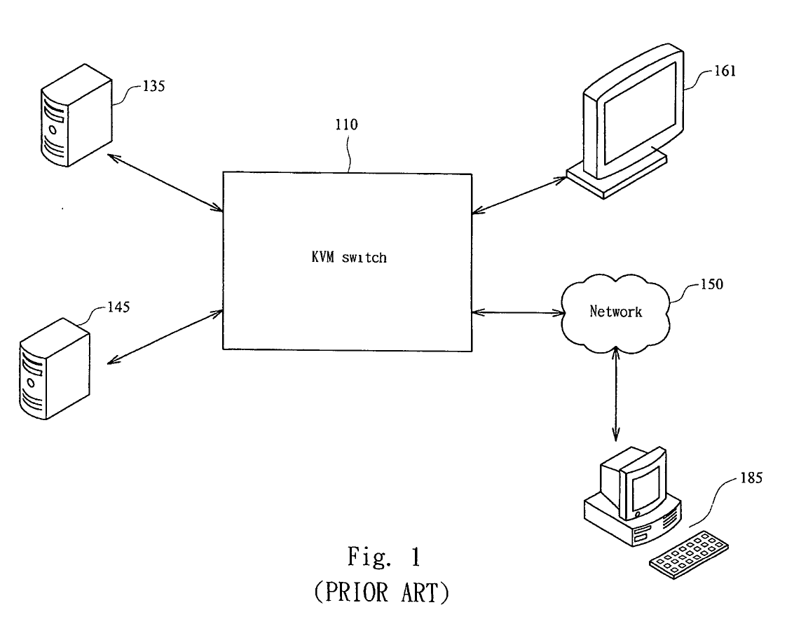

### DESCRIPTION OF THE PREFERRED EMBODIMENTS

Reference will now be made in detail to the present preferred embodiments of the invention, examples of which are illustrated in the accompanying drawings. Wherever possible, the same reference numbers are used in the drawings and the description to refer to the same or like parts.

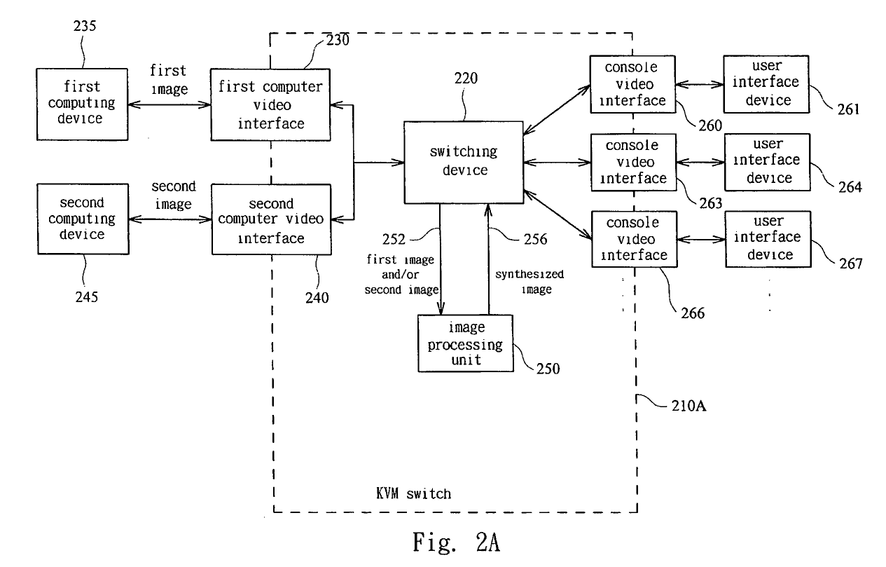

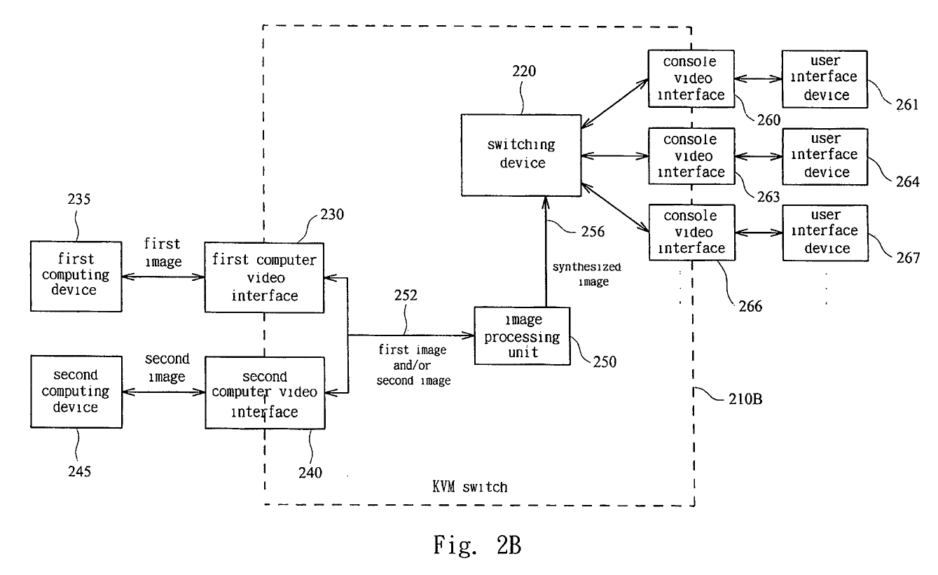

FIG. 2A is a functional block diagram depicting a KVM switch of one preferred embodiment of the present invention. The KVM switch 210 has a switching device 220, a first computer video interface 230, a second computer video interface 240, an image processing unit 250 and console video interfaces 260, 263 and 266. The first computer video interface 230 is coupled to a first computing device 235, the second computer video interface 240 is coupled to a second computing device 245, and the console video interfaces 260, 263 and 266 are coupled to a plurality of user interface devices 261, 264 and 267 individually.

The switching device 220 is arranged to route signals between sets of user interface devices and the computing devices, wherein the switching device 220 selects the first computing device 235 and the second computing device 245 from the computing devices to be connected to one or more of the set of user interface devices 261,264 and 267. The switching device 220 can be implemented by the chips available on market, such as ADI-AD9108. The first computer video interface 230 is arranged to receive a first image from the first computing device 235, and the second computer video interface 240 is arranged to receive a second image from the second computing device 245. The image processing unit 250 coupled to the first computer video interface 230 and the second computer video interface 240 is arranged to compose the first image and the second image (transmitted by path 252) to be a synthesized image 256. The console video interfaces 260,263 and 266 electrically connected to the switching device 220 and the image processing unit 250 is arranged to selectively output one of the first image, the second image and the synthesized image to one or more of the set of user interface devices 261,264 and 267.

Nowadays, the ASIC has abundant functions integrated on one single chip. In the KVM switch 210, the first computer video interface 230, the second computer video interface 240, the image processing unit 250 and the console video interfaces 260,263 and 266 can be integrated into one ASIC, thereby providing for more efficient and flexible chip design and troubleshooting.

In addition, the first computer video interface 230 and the second computer video interface 240 can receive more than one image by time-division technology. The console video interfaces 260,263 and 266 are available on the market, such as Digital Visual Interface (DVI) or D-SUB interface.

FIG. 2B is a functional block diagram depicting a KVM switch of another preferred embodiment of the present invention. The difference between FIG. 2 and FIG. 2B is that the first computer video interface 230 and the second computer video interface 240 of FIG. 2B are coupled to the image processing unit 250 directly, and the image processing unit 250 is coupled to switching device 220. The working theories of the preferred embodiments of FIG. 2A and FIG. 2B are the same, and the switching device 220 can be implemented by the chips available on market, such as ADI-AD9108.

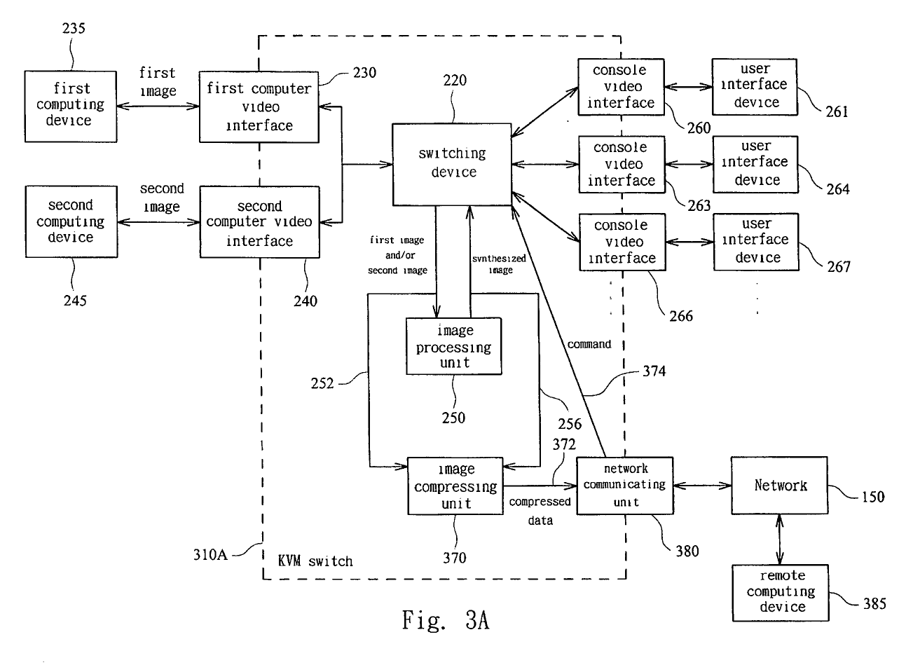

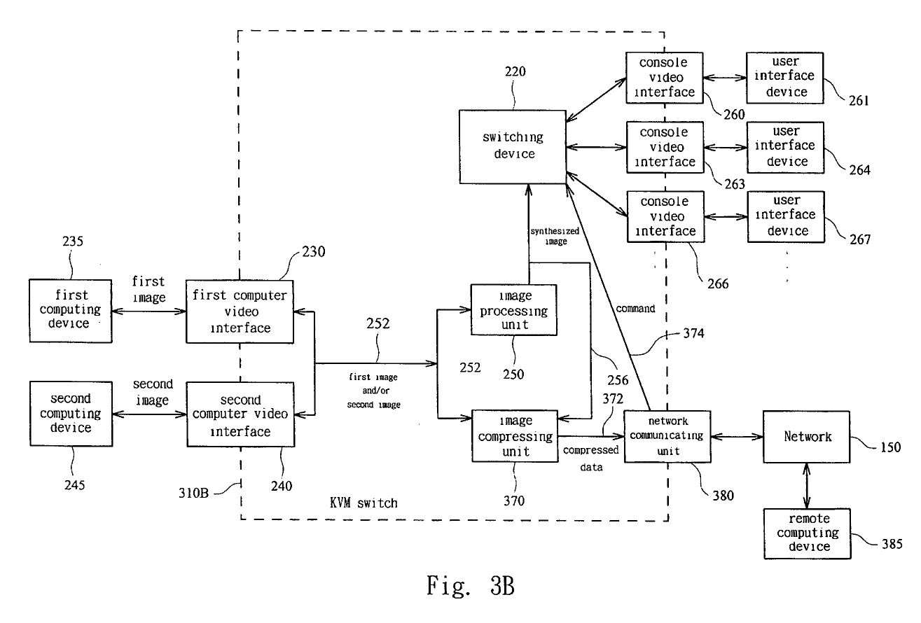

FIG. 3A is a functional block diagram depicting a KVM switch of another preferred embodiment of the present invention. Compared with the KVM switch 210 shown in FIG. 2A, the KVM switch 310 of this preferred embodiment has additional units, image compressing unit 370 and network communicating unit 380, as compared to the KVM switch 210 of FIG. 2A. The image compressing unit 370 coupled to the first computer video interface 230, the second computer video interface 240 and the image processing unit 250 is used to compress at least one of the first image, the second image (transmitted by path 252) and the synthesized image 256 into a compressed data 372. A network communicating unit 380 coupled to the image compressing unit 370 and the switching device 220 is arranged to output the compressed data 372 to a remote computing device 385 through a network 150. The switching device 220 can be implemented by the chips available on market, such as ADI-AD9108. The user can use the remote computing device 385 to transmit a command (transmitted by path 374) by the network 150 and the network communicating unit 380 to the switching device 220. By the same design as the embodiment of FIG. 3A, the KVM switch 310, the first computer video interface 230, the second computer video interface 240, the image processing unit 250 and the console video interfaces 260,263 and 266 can be integrated into one ASIC.

FIG. 3B is a functional block diagram depicting a KVM switch of another preferred embodiment of the present invention. The difference between FIG. 3A and FIG. 3B is that the first computer video interface 230 and the second computer video interface 240 of FIG. 3B are coupled to the image processing unit 250 and the image compressing unit 370 directly, and the image processing unit 250 is coupled to switching device 220. The working theories of the preferred embodiments of FIG. 3A and FIG. 3B are the same, and the switching device 220 can be implemented by the chips available on market, such as ADI-AD9108.

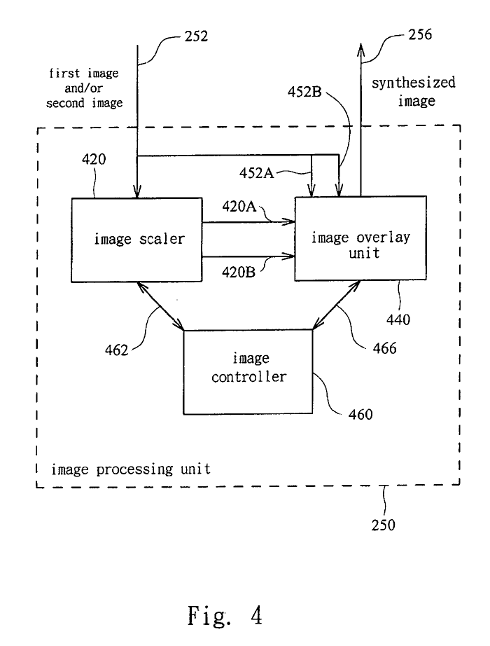

FIG. 4 is a functional block diagram depicting an image processing unit of one preferred embodiment of the present invention. The image processing unit 250 has an image scaler 420, an image overlay unit 440 and an image controller 460. The image scaler 420 coupled to the first computer video interface 230 and the second computer video interface 240 is used to shrink or enlarge at least one of the first image and the second image (transmitted by path 252).

The image overlay unit 440 is coupled to the first computer video interface 230, the second computer video interface 240 and the image scaler 420. The image overlay unit 440 is used to selectively overlay these images, such as a first image 452A, a second image 452B, a first scaled image 420A, or a second scaled image 420B, to be the synthesized image 256. The image controller 460 coupled to the switching device 220, the image scaler 420 and the image overlay unit 440 is used to control the image scaler 420 for changing the scales of the first image 452A and/or the second image 452B and the image overlay unit 440 to compose these images to be the synthesized image 256 by control signals 462 and 466. Otherwise, the control signals 462 and 466 also control the image scaler 420 to output the first scaled image 420A and the second scaled image 420B to the image overlay unit 440.

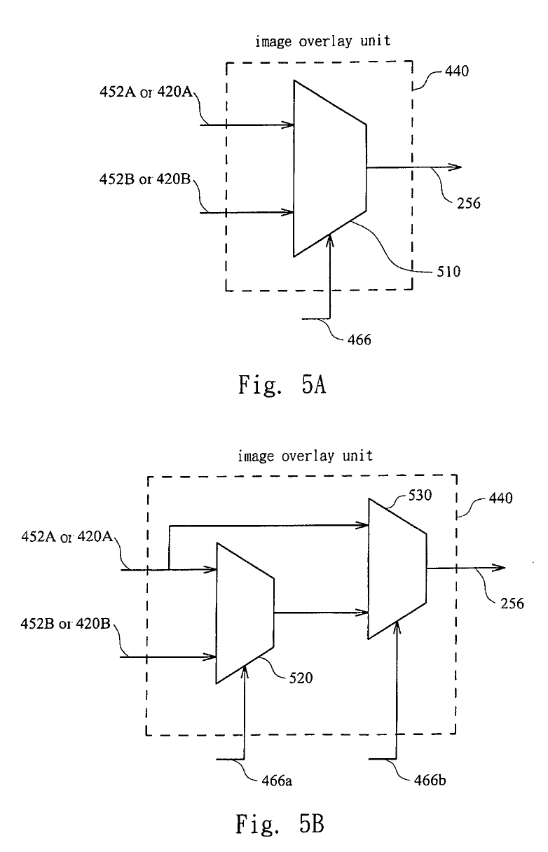

FIG. 5A is a functional block diagram depicting an image overlay unit of one preferred embodiment of the present invention. The multiplexer 510 is a multifunctional multiplexer or a regular multiplexer. The image overlay unit 440 uses the multiplexer 510 to overlay the first image 452A, the second image 452B, the first scaled image 420A, or the second scaled image 420B to be the synthesized image 256; and the multiplexer 510 is controlled by the control signal 466 generated by the image controller 460. The control signal 466 also controls the image overlay unit 440 to output the synthesized image 256.

FIG. 5B is a functional block diagram depicting an image overlay unit of another preferred embodiment of the present invention. The image overlay unit 440 uses two multiplexers 520 and 530 connected in series to overlay the first image 452A, the second image 452B, the first scaled image 420A, or the second scaled image 420B to be the synthesized image 256; and the multiplexers 520 and 530 are controlled by the control signals 466a and 466b generated by the image controller 460. The control signals 466a and 466b also control the image overlay unit 440 to output the synthesized image 256. For example, the control signal 466a controls the multiplexer 520 to select and output the second scaled image 420B into the multiplexer 530, and then the control signal 466b controls the multiplexer 530 to overlay the first image 452A with the second scaled image 420B to be a synthesized image 256.

The synthesized image 256 generated by the image processing unit 250 described above is a picture-in-picture image or a picture-on-picture image. When the synthesized image 256 is a picture-in-picture image, the smaller picture can be a transparent image to show the image under itself, or can be an opaque image to cover the image under itself.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. A KVM switch for at least one set of user interface devices to share a plurality of computing devices, the KVM switch comprising:
a switching device, arranged to route signals between the set of user interface devices and the computing devices, wherein the switching device selects a first computing device and a second computing device from the computing devices to be connected to the set of user interface devices;
a first computer video interface electrically connected to the switching device, arranged to receive a first image from the first computing device;
a second computer video interface electrically connected to the switching device, arranged to receive a second image from the second computing device;
an image processing unit coupled to the first computer video interface and the second computer video interface, arranged to compose the first image and the second image to be a synthesized image, wherein the image processing unit comprises:
an image scaler coupled to the first computer video interface and the second computer video interface, arranged to shrink or enlarge at least one of the first image and the second image; and
at least one console video interface electrically connected to the image processing unit, arranged to output one of the first image, the second image and the synthesized image to the set of user interface devices.

2. The KVM switch as claimed in claim 1, further comprising an ASIC, wherein the first computer video interface, the second computer video interface, the image processing unit and the console video interface are integrated into the ASIC.

3. The KVM switch as claimed in claim 1, wherein one of the first computer video interface and the second computer video interface receives more than one image by time-division technology.

4. The KVM switch as claimed in claim 1, wherein the image processing unit comprises:
an image overlay unit coupled to the first computer video interface, the second computer video interface and the image scaler, arranged to selectively overlay the images; and
an image controller coupled to the switching device, the image scaler and the image overlay unit, arranged to control the image scaler and the image overlay unit to compose the images to be the synthesized image.

5. The KVM switch as claimed in claim 4, wherein the image overlay unit comprises:
a multiplexer arranged to overlay the images to be the synthesized image, and the synthesized image has a transparent or opaque sub-image.

6. The KVM switch as claimed in claim 4, wherein the image overlay unit comprises:
two multiplexers of series connection, arranged to overlay the images to be the synthesized image, and the synthesized image has the transparent or opaque sub-image, wherein one of the multiplexers receives an output from the other one of the multiplexers.

7. The KVM switch as claimed in claim 1, wherein the synthesized image is a picture-in-picture image or a picture-on-picture image.

8. The KVM switch as claimed in claim 1, further comprising:
an image compressing unit coupled to the first computer video interface, the second computer video interface and the image processing unit, arranged to compress at least one of the first image, the second image and the synthesized image into a compressed data; and
a network communicating unit coupled to the image compressing unit and the switching device, arranged to output the compressed data to a remote computing device.

9. A KVM switch for at least one set of user interface devices and at least one remote computing device to share a plurality of computing devices via a network, the KVM switch comprising:
a switching device, arranged to route signals between the set of user interface devices, at least one remote computing device and the computing devices, wherein the switching device selects a first computing device and a second computing device from the computing devices to be connected to the set of user interface devices;
a first computer video interface electrically connected to the switching device, arranged to receive a first image from the first computing device;
a second computer video interface electrically connected to the switching device, arranged to receive a second image from the second computing device;
an ASIC, further comprising:
an image processing unit coupled to the first computer video interface and the second computer video interface, arranged to compose the first image and the second image to be a synthesized image;
an image scaler coupled to the first computer video interface and the second computer video interface, arranged to shrink or enlarge at least one of the first image and the second image; and
an image compressing unit coupled to the first computer video interface, the second computer video interface and the image processing unit, arranged to compress at least one of the first image, the second image and the synthesized image into a compressed data;
at least one console video interface electrically connected to the image processing unit, arranged to selectively output the first image, the second image and the synthesized image to the set of user interface devices; and
a network communicating unit coupled to the image compressing unit and the switching device, arranged to output the compressed data to a remote computing device.

10. The KVM switch as claimed in claim 9, wherein at least one of the first computer video interface and the second computer video interface receives more than one image by time-division technology.

11. The KVM switch as claimed in claim 9, wherein the image processing unit comprises:
an image overlay unit coupled to the first computer video interface, the second computer video interface and the image scaler, arranged to selectively overlay the images; and
an image controller coupled to the switching device, the image scaler and the image overlay unit, arranged to control the image scaler and the image overlay unit to compose the images to be the synthesized image

12. The KVM switch as claimed in claim 11, wherein the image overlay unit comprises:
a multiplexer arranged to overlay the images to be the synthesized image, and the synthesized image has a transparent or opaque sub-image.

13. The KVM switch as claimed in claim 11, wherein the image overlay unit comprises:
two multiplexers of series connection, arranged to overlay the images to be the synthesized image, and the synthesized image has the transparent or opaque sub-image, wherein one of the multiplexers receives an output from the other one of the multiplexers.

14. The KVM switch as claimed in claim 9, wherein the synthesized image is a picture-in-picture image or a picture-on-picture image.

15. A computer switching method for a set of user interface devices to share a plurality of computing devices via a network, the method comprising:
using a switching device to route signals between the set of user interface devices and the computing devices, and selecting a first computing device and a second computing device from the computing devices to be connected to the set of user interface devices;
using a first computer video interface to receive a first image from the first computing device;
using a second computer video interface to receive a second image from the second computing device;
using an image processing unit to compose the first image and the second image to be a synthesized image;
using at least one console video interface to selectively output the first image, the second image and the synthesized image to the set of user interface devices;
using an image compressing unit to compress at least one of the first image, the second image and the synthesized image into a compressed data; and
using a network communicating unit to output the compressed data to a remote computing device.

16. The method as claimed in claim 15, wherein using at least one of the first computer video interface and the second computer video interface is using time-division technology to receive more than one image.

17. The method as claimed in claim 15, wherein using the image processing unit comprises:
using an image scaler to shrink or enlarge at least one of the first image and the second image;
using an image overlay unit to selectively overlay the images; and
using an image controller to control the image scaler and the image overlay unit to compose the images to be the synthesized image

18. The method as claimed in claim 17, wherein using the image overlay unit comprises:
using a multiplexer to overlay the images to be the synthesized image with a transparent or opaque sub-image.

19. The method as claimed in claim 17, wherein using the image overlay unit comprises:
using two multiplexers of series connection, to overlay the images to be the synthesized image with the transparent or opaque sub-image.

20. The method as claimed in claim 15, further comprising using an image processing unit to compose the first image and the second image to be the synthesized image, and the synthesized image is a picture-in-picture image or a picture-on-picture image.
